(19) United States
(12) Patent Application Publication
(10) Pub. No.: US 2019/0251566 A1
(43) Pub. Date: Aug. 15, 2019

(54) MANAGING PRIVATE TRANSACTIONS ON BLOCKCHAIN NETWORKS BASED ON WORKFLOW

(71) Applicant: Alibaba Group Holding Limited, George Town (KY)

(72) Inventors: Dong Pan, Hangzhou (CN); Wenbin Zhang, Hangzhou (CN); Xuebing Yan, Hangzhou (CN)

(73) Assignee: Alibaba Group Holding Limited, George Town (KY)

(21) Appl. No.: 16/390,446

(22) Filed: Apr. 22, 2019

Related U.S. Application Data
(63) Continuation of application No. PCT/CN2018/114426, filed on Nov. 7, 2018.

(51) Int. Cl. G06Q 20/40; H04L 9/06; H04L 9/32; G06Q 20/36

(52) U.S. Cl. CPC G06Q 20/405; H04L 9/0637; G06Q 20/3674; H04L 9/3247; H04L 9/321

(57) ABSTRACT

Implementations of the present disclosure include obtaining, by a first consensus node, a policy of a workflow for sending transaction data between at least two client nodes. The policy is digitally signed by each of the at least two client nodes using a corresponding private key, and the policy includes a routing order of the transaction data between the at least two client nodes. The first consensus node also receives the transaction data submitted by a first of the at least two client nodes. The transaction data is digitally signed by a private key of the first of the at least two client nodes. The first consensus node then forwards the transaction data to a second consensus node or a second of the at least two client nodes based on the policy

### CROSS-REFERENCE TO RELATED APPLICATIONS

This application is a continuation of PCT Application No. PCT/CN2018/114426, filed on Nov. 7, 2018, which is hereby incorporated by reference in its entirety.

### BACKGROUND

Blockchain networks, which can also be referred to as blockchain systems, consensus networks, distributed ledger system (DLS) networks, or blockchain, enable participating entities to securely, and immutably store data. A blockchain can be described as a ledger of transactions and multiple copies of the blockchain are stored across the blockchain network. Example types of blockchains can include public blockchains, consortium blockchains, and private blockchains. A public blockchain is open for all entities to use the blockchain, and participate in the consensus process. A consortium blockchain is a blockchain where the consensus process is controlled by a pre-selected set of nodes. A private blockchain is provided for a particular entity, which centrally controls read and write permissions.

Some blockchain systems can include consensus nodes and client nodes (or users) that use the blockchain network. On the one hand, the consensus nodes communicate with other consensus nodes to reach consensus. On the other hand, the consensus nodes communicate with client nodes to accept and add new transactions to the blocks. In some cases, the client nodes may not want transaction data submitted to a blockchain for consensus to be viewable by the consensus nodes. In some cases, the consensus nodes also communicate with networks of pre-selected nodes of a consortium system or other core systems with different security levels. As such, boundaries can be set for different types of communications to protect data privacy and security.

### SUMMARY

Implementations of the present disclosure are directed to managing private transactions between client nodes through blockchain networks based on workflow. More particularly, implementations of the present disclosure are directed to configuring private communication channels between blockchain client nodes for synchronizing private transaction data.

In some implementations, actions include obtaining, by a first consensus node, a policy of a workflow for sending transaction data between at least two client nodes, the policy being digitally signed by each of the at least two client nodes using a corresponding private key, and the policy includes a routing order of the transaction data between the at least two client nodes; receiving the transaction data submitted by a first of the at least two client nodes, the transaction data being digitally signed by a private key of the first of the at least two client nodes; and forwarding the transaction data to a second consensus node or a second of the at least two client nodes based on the policy. Other implementations include corresponding systems, apparatus, and computer programs, configured to perform the actions of the methods, encoded on computer storage devices.

These and other implementations may each optionally include one or more of the following features: receiving, from a last client node in the routing order of the at least two client nodes, the transaction data digitally signed by each of the at least two client nodes using the corresponding private key; determining that the transaction data is valid based on a consensus process of a blockchain; recording a hashed value of the transaction data on the blockchain; the first of the at least two client nodes is the first client node in the routing order; the second consensus node is trusted by the second client node in the routing order; the first consensus node is trusted by the first of the at least two client nodes and the second of the at least two client nodes; the transaction data is digitally signed by the first of the at least two client nodes; the policy includes an address of each of the at least two client nodes and consensus nodes trusted by the at least two client nodes.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example environment that can be used to execute implementations of the present disclosure.

FIG. 2 depicts an example conceptual architecture in accordance with implementations of the present disclosure.

FIG. 3 depicts an example blockchain system with private communication channels between client nodes in accordance with implementations of the present disclosure.

FIG. 4 depicts an example method of managing private transactions in accordance with implementations of the present disclosure.

Like reference symbols in the various drawings indicate like elements.

### DETAILED DESCRIPTION

Implementations of the present disclosure are directed to managing private transactions between client nodes through blockchain networks based on workflow. More particularly, implementations of the present disclosure are directed to configuring private communication channels between blockchain client nodes for synchronizing private transaction data.

In some implementations, actions include obtaining, by a first consensus node, a policy of a workflow for sending transaction data between at least two client nodes, the policy being digitally signed by each of the at least two client nodes using a corresponding private key, and the policy includes a routing order of the transaction data between the at least two client nodes; receiving the transaction data submitted by a first of the at least two client nodes, the transaction data being digitally signed by a private key of the first of the at least two client nodes; and forwarding the transaction data to a second consensus node or a second of the at least two client nodes based on the policy.

To provide further context for implementations of the present disclosure, and as introduced above, blockchain networks, which can also be referred to as consensus networks (e.g., made up of peer-to-peer nodes), distributed ledger system, or simply blockchain, enable participating entities to securely and immutably conduct transactions, and store data. A blockchain can be provided as a public blockchain, a private blockchain, or a consortium blockchain. Implementations of the present disclosure are described in further detail herein with reference to a public blockchain, which is public among the participating entities. It is contemplated, however, that implementations of the present disclosure can be realized in any appropriate type of blockchain.

In a consortium blockchain, the consensus process is controlled by an authorized set of nodes, one or more nodes being operated by a respective entity (e.g., an enterprise). For example, a consortium of ten (10) entities (e.g., companies) can operate a consortium blockchain system, each of which operates at least one node in the consortium blockchain. Accordingly, the consortium blockchain system can be considered a private network with respect to the participating entities. In some examples, each entity (node) must sign every block in order for the block to be valid, and added to the blockchain. In some examples, at least a sub-set of entities (nodes) (e.g., at least 7 entities) must sign every block in order for the block to be valid, and added to the blockchain. An example consortium blockchain system includes Quorum, developed by J.P. Morgan Chase & Co. of New York, N.Y. Quorum can be described as an enterprise-focused, permissioned blockchain infrastructure specifically designed for financial use cases. Quorum is built off of Go Ethereum, the base code for the Ethereum blockchain, which is provided by the Ethereum Foundation of Zug, Switzerland.

In general, a consortium blockchain system supports transactions between entities participating, with permission, in the consortium blockchain system. A transaction is shared with all of the nodes within the consortium blockchain system, because the blockchain is replicated across all nodes. That is, all nodes are in perfect state of consensus with respect to the blockchain. To achieve consensus (e.g., agreement to the addition of a block to a blockchain), a consensus protocol is implemented within the consortium blockchain network. An example consensus protocol includes, without limitation, proof-of-work (POW) implemented in the Bitcoin network.

Implementations of the present disclosure are directed to managing private transactions between client nodes through blockchain networks based on workflow. More particularly, implementations of the present disclosure are directed to configuring private communication channels between blockchain client nodes for synchronizing private transaction data.

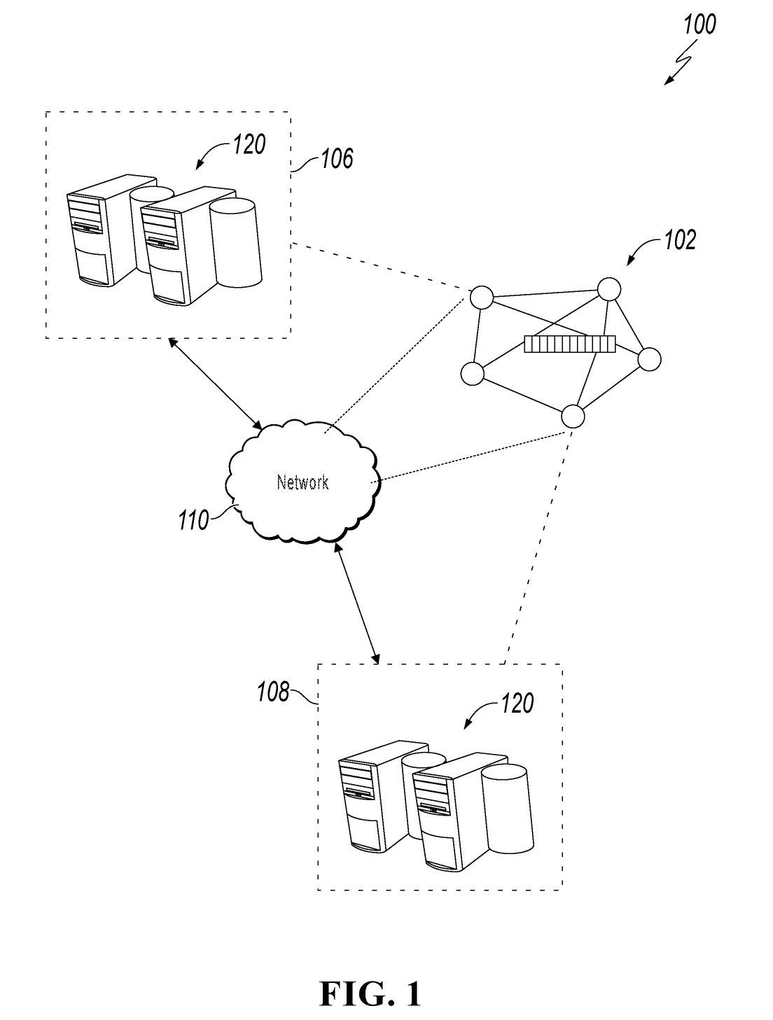

FIG. 1 depicts an example environment 100 that can be used to execute implementations of the present disclosure. In some examples, the example environment 100 enables entities to participate in a public blockchain 102. The example environment 100 includes computing systems 106, 108, and a network 110. In some examples, the network 110 includes a local area network (LAN), wide area network (WAN), the Internet, or a combination thereof, and connects web sites, user devices (e.g., computing devices), and back-end systems. In some examples, the network 110 can be accessed over a wired and/or a wireless communications link.

In the depicted example, the computing systems 106, 108 can each include any appropriate computing system that enables participation as a node in the consortium blockchain system 102, for storing transactions in a blockchain 104. Example computing devices include, without limitation, a server, a desktop computer, a laptop computer, a tablet computing device, and a smartphone. In some examples, the computing systems 106, 108 host one or more computer-implemented services for interacting with the consortium blockchain system 102. For example, the computing system 106 can host computer-implemented services of a first entity (e.g., user A), such as a transaction management system that the first entity uses to manage its transactions with one or more other entities (e.g., other users). The computing system 108 can host computer-implemented services of a second entity (e.g., user B), such as transaction management system that the second entity uses to manage its transactions with one or more other entities (e.g., other users). In the example of FIG. 1, the consortium blockchain system 102 is represented as a peer-to-peer network of nodes, and the computing systems 106, 108 provide nodes of the first entity, and second entity respectively, which participate in the consortium blockchain system 102.

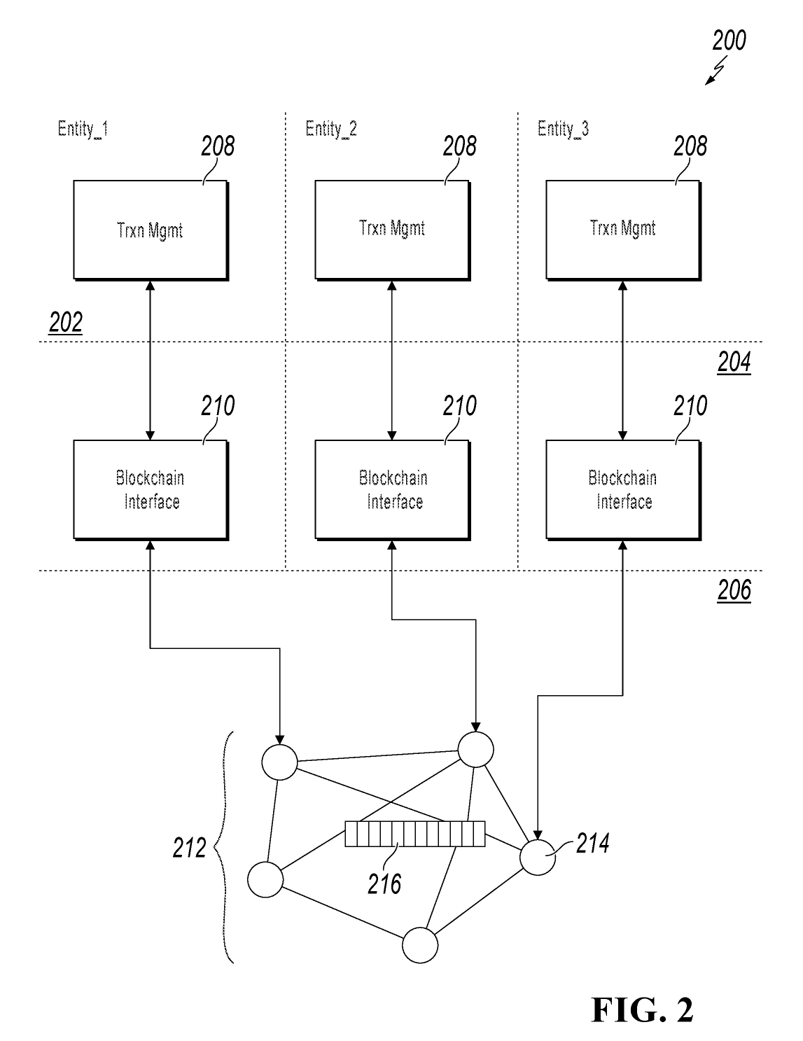

FIG. 2 depicts an example conceptual architecture 200 in accordance with implementations of the present disclosure. The example conceptual architecture 200 includes an entity layer 202, a hosted services layer 204, and a blockchain layer 206. In the depicted example, the entity layer 202 includes three entities, Entity_1 (E1), Entity_2 (E2), and Entity_3 (E3), each entity having a respective transaction management system 208.

In the depicted example, the hosted services layer 204 includes blockchain interfaces 210 for each transaction management system 208. In some examples, a respective transaction management system 208 communicates with a respective blockchain interface 210 over a network (e.g., the network 110 of FIG. 1) using a communication protocol (e.g., hypertext transfer protocol secure (HTTPS)). In some examples, each blockchain interface 210 provides a communication connection between a respective transaction management system 208, and the blockchain layer 206. More particularly, each blockchain interface 210 enables the respective entity to conduct transactions recorded in a consortium blockchain system 212 of the blockchain layer 206. In some examples, communication between a blockchain interface 210, and the blockchain layer 206 is conducted using remote procedure calls (RPCs). In some examples, the blockchain interfaces 210 “host” consensus nodes for the respective transaction management systems 208. For example, the blockchain interfaces 210 provide the application programming interface (API) for access to the consortium blockchain system 212.

A blockchain system can include consensus nodes and client nodes. The consensus nodes can participate in the consensus process. The client nodes can use the blockchain system, but do not participate in the consensus process. In some implementations, the consensus nodes can participate in the consensus process while using the blockchain system for other purposes. In some implementations, the consensus nodes can communicate with client nodes, so that users can use the client nodes to submit transactions to the blockchain. The consensus nodes can also communicate with each other to reach consensus in order to add the transactions submitted by the client nodes to the blockchain.

In some implementations, a group of client nodes may want to maintain transaction data private from the blockchain network. When new transaction data is generated, data synchronization can be performed to ensure that the group of client nodes have the same data. The transaction data can be routed through consensus nodes trusted by the client nodes. The group of client nodes and the routing consensus nodes can form a workflow, which establishes routing of transaction data based on a policy endorsed by digital signatures of all client nodes involved. When data synchronization is performed according to a workflow, each client node that receives the transaction data can add its digital signature to the data. It then forwards the digitally signed copy through the workflow to the next client node until the last client node in the workflow is reached. The last client node then adds its digital signature and submit the transaction data to a consensus node for consensus. After a consensus is reached, the transaction data can be recorded on the blockchain in hash. As such, a client node can verify the authenticity of private data received from another client node on the workflow by comparing the data to the hashed data recorded on the blockchain.

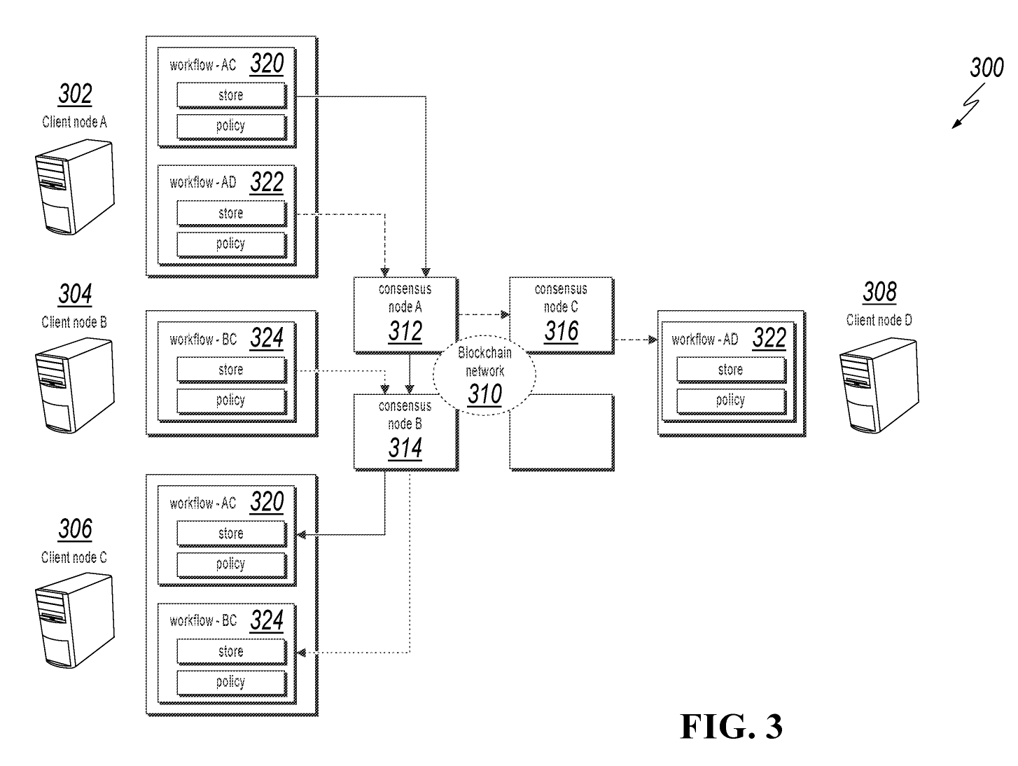

FIG. 3 depicts an example blockchain system 300 with private communication channels between client nodes in accordance with implementations of the present disclosure. At a high-level, the example blockchain system 300 includes client node A 302, a client node B 304, a client node C 306, and a client node D 308, and a blockchain network 310. The blockchain network 310 includes a consensus node A 312, a consensus node B 314, and a consensus node C 316.

Three workflows are also illustrated in FIG. 3. For illustration purposes, workflow-AC 320 is connected by solid arrows. The workflow-AC 320 involves the client node A 302, the consensus node A 312, trusted by the client node A 302, the consensus node B 314, trusted by the client node C 306, and the client node C 306. Workflow-AD 322 is connected by dashed arrows. The workflow-AD involves the client node A 302, the consensus node A 312, trusted by the client node A 302, the consensus node C 316, trusted by the client node D 308, and the client node D 308. Workflow-BC 324 is connected by dotted arrows. The workflow-BC 324 involves the client node B 304, the consensus node B 314, trusted by the client node B 304 and the client node D 308, and the client node D 308. It is to be understood that the specific numbers of client nodes, consensus nodes, and workflows depicted in FIG. 3 are for illustration purposes. The example blockchain system 300 can include more or less client nodes, consensus nodes, or workflows than those depicted, depending on specific implementations.

Data transmission in the workflow can be performed based on a policy stored in a smart contract. The policy can be public to the client nodes and the blockchain network under the smart contract. Using workflow-AC 320 as an example, a policy can be made to include the addresses of the client node A 302, the client node C 306, the consensus node A 312 trusted by the client node A 302, and the consensus node B 314 trusted by the client node C 306. An example code of the policy can be expressed as:

```
  “Workflow_AC”: {
“client_A_addr”: “client_A_trust_consensus_node_addr”,
“client_C_addr”: “client_C_trust_consensus_node_addr”
  }
```

The policy can be made by any party, and is endorsed by digital signatures of all client nodes in the corresponding workload to be performed. When new transaction data is generated and stored by the client node A 302, the client node A 302 can identify the workflow policies it is related to. In the present example 300, the client node A 302 can find a policy of workflow-AC 320 and a policy of workflow-AD 324. The client node A 302 can then verify if the policy of workflow-AC 320 has the correct digital signatures of the client node A 302 and the client node C 306 using their corresponding public keys. The client node A 302 can also verify whether the policy of workflow-AD 324 has the correct digital signatures of the client node A 302 and the client node D 308.

For the workflow-AC 320, if the digital signatures on the policy are valid, the client node A 302 can digitally sign the transaction data, and send it to the address of consensus node A 312 based on the policy of workflow AC 320. After the consensus node A 312 receives the transaction data, it forwards the transaction data to the address of the consensus node B 314. The consensus node B 314 forwards the transaction data to the client node C 306. After receiving the transaction data, the client node C 306 can verify the digital signature of the client node A 302 using the client node A's 302 public key. If the signature is correct, the client node C 306 can store a copy of the transaction data to its private database. The client node C 306 can digitally sign the transaction data and submit it to the blockchain network 310. The blockchain network 310 can record the transaction data in hash on the blockchain, so that the actual transaction data is not publicly viewable, but can be verified by the client nodes in the workflow AC 320.

Similarly, for the workflow-AD 322, if the digital signatures on the policy are valid, the client node A 302 can digitally sign the transaction data and send it to the address of consensus node A 312 based on the policy of workflow AD 322. After the consensus node A 312 receives the transaction data, it forwards the transaction data to the address of the consensus node C 316. The consensus node C 316 then forwards the transaction data to the client node D 308. After receiving the transaction data, the client node D 308 can verify the digital signature of the client node A 302 using the client node A's 302 public key. If the signature is correct, the client node D 308 can store a copy of the transaction data to its private database. The client node D 308 can then digitally sign the transaction data and submit it to the blockchain network 310. The data transmission of workflow-BC 324 can be similarly performed.

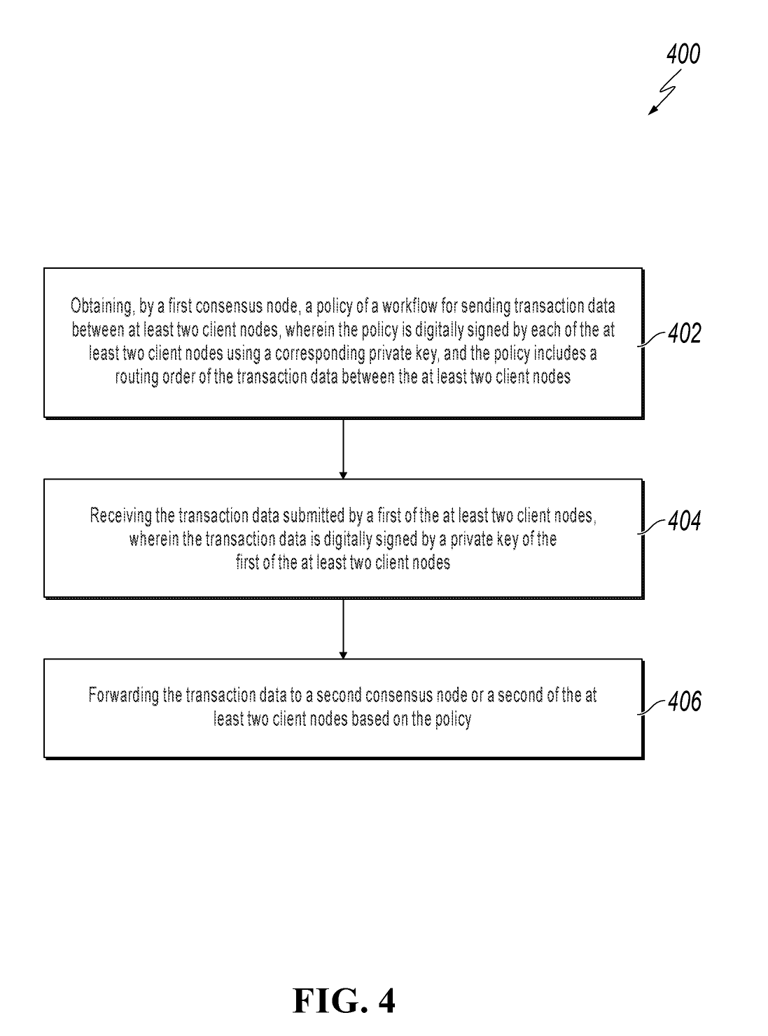

FIG. 4 depicts an example method 400 of managing private transactions in accordance with implementations of the present disclosure. For clarity of presentation, the description that follows generally describes the example process 400 in the context of the other figures in this description. However, it will be understood that the example process 400 can be performed, for example, by any system, environment, software, and hardware, or a combination of systems, environments, software, and hardware, as appropriate. In some implementations, various steps of the example process 400 can be run in parallel, in combination, in loops, or in any order.

At 402, the first consensus node obtains a policy of a workflow for sending transaction data between at least two client nodes. In some examples, the policy is digitally signed by each of the at least two client nodes using a corresponding private key. In some examples, the policy includes a routing order of the transaction data between the at least two client nodes. In some implementations, the first of the at least two client nodes is the first client node in the routing order. In some implementations, the transaction data is digitally signed by the first of the at least two client nodes. In some implementations, the policy includes an address of each of the at least two client nodes and consensus nodes trusted by the at least two client nodes.

At 404, the first consensus node receives the transaction data submitted by a first of the at least two client nodes, wherein the transaction data is digitally signed by a private key of the first of the at least two client nodes.

At 406, the first consensus node forwards the transaction data to a second consensus node or a second of the at least two client nodes based on the policy. In some implementations, the first consensus node further receives, from a last client node in the routing order of the at least two client nodes, the transaction data digitally signed by each of the at least two client nodes using the corresponding private key. The first consensus node also determines that the transaction data is valid based on a consensus process of a blockchain and records a hashed value of the transaction data on the blockchain. In some implementations, the second consensus node is trusted by the second client node in the routing order. In some implementations, the first consensus node is trusted by the first of the at least two client nodes and the second of the at least two client nodes.

Implementations and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, implementations can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

1. A computer-implemented method for private data transactions through blockchain networks based on a workflow, comprising:
obtaining, by a first consensus node, a policy of a workflow for sending transaction data between at least two client nodes, the policy being digitally signed by each of the at least two client nodes using a corresponding private key, and the policy includes a routing order of the transaction data between the at least two client nodes;
receiving the transaction data submitted by a first of the at least two client nodes, the transaction data being digitally signed by a private key of the first of the at least two client nodes; and
forwarding the transaction data to a second consensus node or a second of the at least two client nodes based on the policy.

2. The computer-implemented method of claim 1, further comprising:
receiving, from a last client node in the routing order of the at least two client nodes, the transaction data digitally signed by each of the at least two client nodes using the corresponding private key;
determining that the transaction data is valid based on a consensus process of a blockchain; and
recording a hashed value of the transaction data on the blockchain.

3. The computer-implemented method of claim 1, wherein the first of the at least two client nodes is a first client node in the routing order.

4. The computer-implemented method of claim 1, wherein the second consensus node is trusted by a second client node in the routing order.

5. The computer-implemented method of claim 1, wherein the first consensus node is trusted by the first of the at least two client nodes and the second of the at least two client nodes.

6. The computer-implemented method of claim 1, wherein the transaction data is digitally signed by the first of the at least two client nodes.

7. The computer-implemented method of claim 1, wherein the policy includes an address of each of the at least two client nodes and consensus nodes trusted by the at least two client nodes.

8. A non-transitory, computer-readable medium storing one or more instructions executable by a computer system to perform operations comprising:
obtaining, by a first consensus node, a policy of a workflow for sending transaction data between at least two client nodes, the policy being digitally signed by each of the at least two client nodes using a corresponding private key, and the policy includes a routing order of the transaction data between the at least two client nodes;
receiving the transaction data submitted by a first of the at least two client nodes, the transaction data being digitally signed by a private key of the first of the at least two client nodes; and
forwarding the transaction data to a second consensus node or a second of the at least two client nodes based on the policy.

9. The non-transitory, computer-readable medium of claim 8, the operations further comprising:
receiving, from a last client node in the routing order of the at least two client nodes, the transaction data digitally signed by each of the at least two client nodes using the corresponding private key;
determining that the transaction data is valid based on a consensus process of a blockchain; and
recording a hashed value of the transaction data on the blockchain.

10. The non-transitory, computer-readable medium of claim 8, wherein the first of the at least two client nodes is a first client node in the routing order.

11. The non-transitory, computer-readable medium of claim 8, wherein the second consensus node is trusted by a second client node in the routing order.

12. The non-transitory, computer-readable medium of claim 8, wherein the first consensus node is trusted by the first of the at least two client nodes and the second of the at least two client nodes.

13. The non-transitory, computer-readable medium of claim 8, wherein the transaction data is digitally signed by the first of the at least two client nodes.

14. The non-transitory, computer-readable medium of claim 8, wherein the policy includes an address of each of the at least two client nodes and consensus nodes trusted by the at least two client nodes.

15. A system, comprising:
one or more computers; and
one or more computer-readable memories coupled to the one or more computers and having instructions stored thereon which are executable by the one or more computers to perform operations comprising:
obtaining, by a first consensus node, a policy of a workflow for sending transaction data between at least two client nodes, the policy being digitally signed by each of the at least two client nodes using a corresponding private key, and the policy includes a routing order of the transaction data between the at least two client nodes;
receiving the transaction data submitted by a first of the at least two client nodes, the transaction data being digitally signed by a private key of the first of the at least two client nodes; and
forwarding the transaction data to a second consensus node or a second of the at least two client nodes based on the policy.

16. The system of claim 15, the operations further comprising:
receiving, from a last client node in the routing order of the at least two client nodes, the transaction data digitally signed by each of the at least two client nodes using the corresponding private key;
determining that the transaction data is valid based on a consensus process of a blockchain; and
recording a hashed value of the transaction data on the blockchain.

17. The system of claim 15, wherein the first of the at least two client nodes is a first client node in the routing order.

18. The system of claim 15, wherein the second consensus node is trusted by a second client node in the routing order.

19. The system of claim 15, wherein the first consensus node is trusted by the first of the at least two client nodes and the second of the at least two client nodes.

20. The system of claim 15, wherein the transaction data is digitally signed by the first of the at least two client nodes.
